(19) United States
(12) Patent Application Publication
(10) Pub. No.: US 2025/0130775 A1
(43) Pub. Date: Apr. 24, 2025

(54) SYSTEM FOR REDUCING WORK DUPLICATION IN PARALLEL AND CONCURRENT SOFTWARE DEVELOPMENT ENVIRONMENTS

(71) Applicant: BANK OF AMERICA CORPORATION, Charlotte, NC (US)

(72) Inventors: Jyothi Gaddam, Hyderabad (IN); Shantonu Ghosh, Hyderabad (IN); Venugopala Rao Randhi, Hyderabad (IN); Rama Venkata S. Kavali, Frisco, TX (US)

(73) Assignee: BANK OF AMERICA CORPORATION, Charlotte, NC (US)

(21) Appl. No.: 18/381,246

(22) Filed: Oct. 18, 2023

(51) Int. Cl. G06F 8/20; G06F 8/71

(52) U.S. Cl. CPC G06F 8/20; G06F 8/71

(57) ABSTRACT

Embodiments of the invention provide a comprehensive system for monitoring, evaluating, and managing code changes in a software development environment. The system comprises a Code Monitoring Subsystem (CMS) that continuously scans servers to identify active jobs and issues alerts based on various conditions. A Code Resolution Subsystem (CRS) aids developers in resolving issues and may include a machine learning (ML) subsystem for suggesting code options. The system also features a Parallel Code Monitoring Subsystem (PCMS) that generates atomic versions of code changes for real-time collaboration among developers. Containers corresponding to code changes are created and subjected to specific tests, with quality assessed through smart contracts. A composite value, serving as a metric for assessing a container's susceptibility to errors, is determined for each container. The system enhances code quality, reduces duplication, and facilitates efficient development.

### TECHNOLOGICAL FIELD

Example embodiments of the present disclosure relate to reducing work duplication in parallel and concurrent software development environments.

### BACKGROUND

In today's technology landscape, software development and deployment occur at a rapid pace, especially in environments that focus on parallel and concurrent activities. This speed introduces challenges such as work duplication, as developers may work on similar functionalities across multiple projects. The fast pace also complicates essential tasks like development, testing, and version control, potentially slowing down overall timelines. Additionally, when multiple teams work on similar tasks, it becomes difficult to determine ownership, leading to possible delays or conflicts. The demands of these various tasks can also strain resources, particularly in complex software architectures. These issues are increasingly relevant as organizations continue to adopt parallel and concurrent development approaches.

Applicant has identified a number of deficiencies and problems associated with reducing work duplication in parallel and concurrent software development environments. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for reducing work duplication in parallel and concurrent software development environments.

In one aspect, a system for reducing work duplication in parallel and concurrent software development environments is presented. The system comprising: a code monitoring subsystem (CMS) configured to: scan and subsequently identify active jobs in a production environment; determine at least one job requiring code modification; transmit control signals configured to notify a plurality of developers of the code modification requirement, wherein the plurality of developers is associated with the at least one job; and a parallel code monitoring subsystem (PCMS) operatively coupled to the CMS and is configured to: receive code changes from the plurality of developers in response to the code modification requirement; upon each save action by a developer, generate an atomic version of each code change; and display the atomic version of each code change to the plurality of developers.

In some embodiments, the system further comprises a code resolution subsystem (CRS) operatively coupled to the CMS, wherein the CRS is configured to: monitor code change development initiated by the plurality of developers upon being notified of the code modification requirement for the at least one job.

In some embodiments, the CRS comprises a machine learning (ML) subsystem configured to: determine past code changes that have addressed similar code modification requirements; and suggest code options to the plurality of developers during the code change development based on at least the past code changes.

In some embodiments, the ML subsystem is further configured to: dynamically update the suggested code options based on ongoing code changes made by the plurality of developers and the past code changes.

In some embodiments, the CMS is further configured to prioritize notifications to the plurality of developers based on their initial code contribution to the at least one job.

In some embodiments, the CMS is further configured to: receive the code changes from the plurality of developers; and create a container for each code change.

In some embodiments, the CMS is further configured to: simulate a production environment; and implement a code test protocol on each container in the simulated production environment.

In some embodiments, the code test protocol comprises a smart contract, wherein the smart contract comprises one or more conditions associated with one or more performance metrics.

In some embodiments, the smart contract is associated with a stakeholder.

In some embodiments, the one or more performance metrics comprises at least complexity, exposure assessment, code quality, resource consumption, test coverage, business value, performance metrics, compliance, and code cost.

In some embodiments, the CMS is further configured to: for each container, determine one or more values for the one or more performance metrics in response to implementing the code test protocol; and deploy the container in an instance in which the one or more values for the one or more performance metrics meets the one or more conditions.

In some embodiments, the CMS is further configured to: for each container, determine one or more weights associated with the one or more performance metrics; and determine a composite value for each container based on at least the one or more weights and the one or more values, wherein the composite value serves as a metric for assessing the container's susceptibility to errors.

In some embodiments, the system further comprises a non-fungible token (NFT) generator, wherein the NFT generator is configured to: generate an NFT for each container, wherein the NFT comprises at least the composite value of the container and a code change associated with the container; and record the NFT in a distributed ledger.

In some embodiments, the NFT generator is further configured to: generate a transaction object for the NFT; deploy the transaction object on the distributed ledger; capture a distributed ledger address associated with the recording; generate a notification indicating that the transaction object has been created for the NFT in the distributed ledger, wherein the notification comprises at least the distributed ledger address; and transmit control signals configured to cause a user input device of the developer associated with the code change to display the notification.

In another aspect, a computer program product for reducing work duplication in parallel and concurrent software development environments is presented. The computer program product comprising a non-transitory computer-readable medium comprising code configured to cause an apparatus to: scan and subsequently identify, active jobs in a production environment; determine at least one job requiring code modification; transmit control signals configured to notify a plurality of developers of the code modification requirement, wherein the plurality of developers are associated with the at least one job; receive code changes from the plurality of developers in response to the code modification requirement; upon each save action by a developer, generate an atomic version of each code change; and display the atomic version of each code change to the plurality of developers.

In yet another aspect, a method for reducing work duplication in parallel and concurrent software development environments is presented. The method comprising: scanning and subsequently identifying, active jobs in a production environment; determining at least one job requiring code modification; transmitting control signals configured to notify a plurality of developers associated with the at least one job of the code modification requirement; receiving code changes from a plurality of developers in response to the code modification requirement; upon each save action by a developer, generating an atomic version of each code change; and displaying the atomic version of each code change to the plurality of developers.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment reducing work duplication in parallel and concurrent software development environments, in accordance with an embodiment of the disclosure;

FIG. 2 illustrates an exemplary machine learning (ML) subsystem architecture, in accordance with an embodiment of the invention;

FIG. 3A illustrates an exemplary process of creating an NFT, in accordance with an embodiment of the invention;

FIG. 3B illustrates an exemplary NFT as a multi-layered documentation of a resource, in accordance with an embodiment of an invention;

FIG. 4 is a data flow diagram 400 illustrating a role of the code monitoring subsystem (CMS) in reducing work duplication in parallel and concurrent software development environments, in accordance with an embodiment of the invention;

FIG. 5 is a data flow diagram 500 illustrating a role of the parallel code monitoring subsystem (PCMS) and code resolution subsystem (CRS) in reducing work duplication in parallel and concurrent software development environments, in accordance with an embodiment of the invention; and

FIG. 6 illustrates a process flow reducing work duplication in parallel and concurrent software development environments, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. For example, the user may be a stakeholder (e.g., developers, quality assurance (QA) engineers, business analysts) associated with the entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the current landscape of technology, the rapid pace of software development and deployment, particularly in environments emphasizing parallel and concurrent activities, presents several challenges. These include work duplication, as developers often work on similar functionalities across multiple projects. The speed of development further complicates essential tasks such as testing and version control, thereby potentially extending overall timelines. Additionally, the issue of determining ownership becomes complex when multiple teams are working on similar tasks, leading to potential delays or conflicts. Resource constraints are also a concern, especially in the context of intricate software architectures. These challenges are becoming increasingly critical as organizations continue to adopt parallel and concurrent development methodologies.

Embodiments of the invention address these challenges. The Code Monitoring Subsystem (CMS) serves as a proactive monitoring tool that may be configured to continuously scan servers to identify active jobs, read associated logs and update a database based on predetermined thresholds or key elements. This enables the CMS to issue alerts under various conditions: job failure, delays, high data volume, or failure to complete tasks within a set timeframe, and/or the like. In addition, the CMS may be configured to trigger alerts when computer resources are nearing depletion. Furthermore, the CMS may be configured to integrate with repository management and project management tools, to identify and notify all the stakeholder such as developers, quality assurance (QA) engineers, business analysts, and/or the like who are associated with a job. In this way, the CMS may ensure that the right individuals are alerted and can take timely action when issues arise in specific jobs. To enhance the alerting process, the CMS may be configured to rank or prioritize notifications based on the number of developers who have contributed code to the job. For instance, if the primary developer fails to acknowledge the alert within a set timeframe, the notification may be escalated to the secondary developer, and so on.

Upon receipt and acknowledgment of a notification, the developer may commence work on resolving the issue, aided by the Code Resolution Subsystem (CRS) to expedite the process. An integrated machine learning (ML) subsystem may be configured to analyze past code changes that have addressed similar code modification requirements. Based on this analysis, the CRS can suggest code options to the developer during the code change development. These suggestions may be generated by comparing the current code modification requirements with past code changes, thereby providing the developer with potentially effective solutions that have been previously implemented. The ML subsystem may be designed adapt dynamically. As the developer makes ongoing code changes, the capabilities of the ML subsystem may allow the CRS to update the suggested code options in real-time. This dynamic updating is based on both the ongoing code changes made by the developer and the past code changes that were determined to be similar. This feature ensures that the code suggestions remain relevant and are continuously refined, facilitating a more efficient and effective code development process.

In entities that span multiple geographic locations, it is possible for multiple developers to be working on the same issue concurrently without awareness of each other's efforts, resulting in duplicated work. For instance, each developer may provide their own version of code change for deployment, addressing the issue. To further enhance collaboration and code quality, a Parallel Code Monitoring Subsystem (PCMS) may continuously monitor each developer working on the same issue. Upon each save action by a developer, the PCMS may be configured to generate an atomic version of the code change, complete with detailed information such as module dependency, database dependency, affected rows, scope of variables, line sequence, test case coverage, and/or the like. In addition, the PCMS may also be configured to provide real-time test case outcomes, indicating the number of passed and failed test cases. These atomic versions are then sent to the other developers working on the same issue, thereby allowing each developer to have precise insight into what the other developers are doing, enhancing collaboration across the entity, and reducing work duplication.

Upon receipt of the code change from the developer, the CMS may be configured to create containers corresponding to the code change submitted by the developer, thereby equipping the developer with the requisite resources for thorough evaluation and testing of each code modification. In cases where a particular issue is being addressed by multiple developers, the CMS may be configured to create containers corresponding to each version of the code change submitted by each developer. These containers may then be subjected to a series of specific tests to assess their quality and functionality. To standardize this testing process, smart contracts may be employed. The smart contract may outline key metrics such as the complexity metrics, exposure assessment, quality metrics, resource consumption, test coverage, business value, performance metrics, compliance score, cost metrics, and/or the like to determine the quality of each container. Containers that meet the conditions specified in the smart contract are automatically eligible for deployment. Individual stakeholders can formulate smart contracts tailored to their unique requirements, featuring specific metrics. Although the metrics may be consistent across different smart contracts, the values or conditional parameters can vary. In the absence of an existing comparable smart contract, the CMS may be configured to produce a predefined smart contract, which is then disseminated for stakeholder approval.

To ensure the robustness and reliability of each container, testing is conducted in a simulated production environment that closely mimics real-world conditions. The performance of each container is evaluated based on a range of metrics, including but not limited to complexity, exposure assessment, code quality, resource consumption, test coverage, business value, performance metrics, compliance, and cost. These metrics are not uniformly weighted; rather, each is assigned a specific weight based on its importance to the entity's objectives. The scores from each metric are then aggregated into a weighted composite score for the container. The composite score may serve as an indication of both the quality of the associated code change and the susceptibility of the container to errors. This composite score, along with the associated code change, is subsequently recorded in the form of a non-fungible token (NFT). This NFT serves as a unique identifier and value representation of the container.

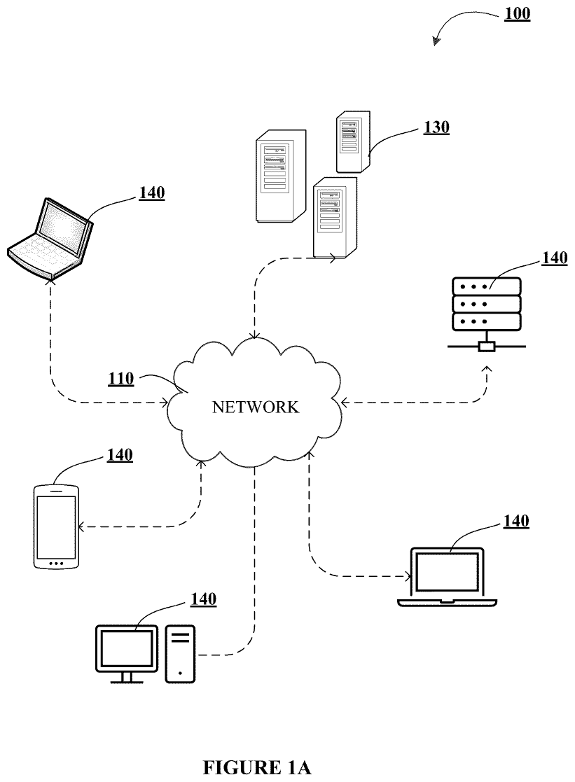

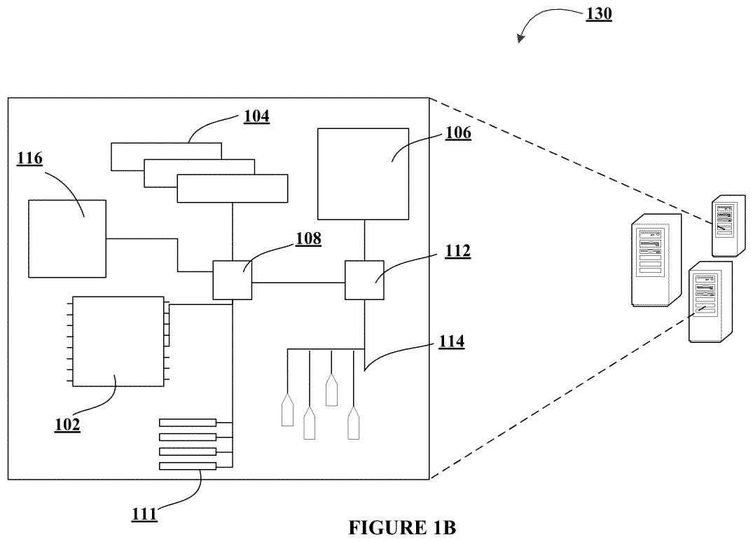

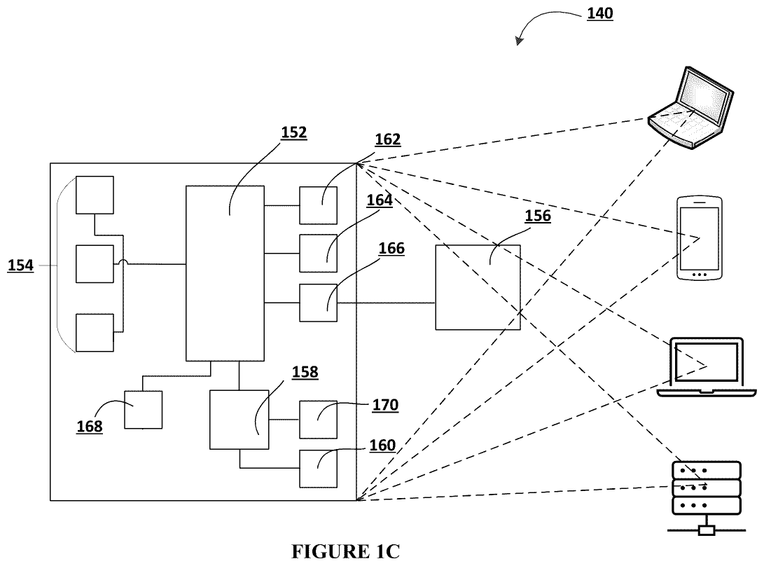

FIGS. 1A-1C illustrate technical components of an exemplary distributed computing environment for reducing work duplication in parallel and concurrent software development environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may include or be operatively coupled to a number of subsystems to execute the portions of processes described herein. A subsystem may refer to a distinct functional unit within a system, designed to perform a specific function or set of functions. In various embodiments, a subsystem may comprise both hardware and software components that work in concert to achieve the designated tasks. For example, in some embodiments, a “subsystem” may include processing circuitry, algorithms, routines, storage media, network interfaces, input/output mechanisms, and the like. In some embodiments, each subsystem may include one or more units, each designed to perform a specific function or set of functions within the broader scope of the subsystem's objectives. These units may utilize the processing circuitry, algorithms, routines, storage media, network interfaces, and input/output mechanisms associated with the subsystem to execute their designated tasks. In some embodiments, subsystem may operate independently or in conjunction with other subsystems to achieve system-wide objectives. In some cases, similar or common hardware may be shared across multiple subsystems, obviating the need for duplicate hardware. Components of a subsystem may be housed together or separately, depending on system architecture and functional requirements.

As described in further detail herein, in example embodiments, the processor 102 may include or be operatively coupled to, (i) CMS-CMS may be configured to continuously monitor the production environment and the servers associated therewith for active jobs, read logs, and update a database based on set criteria. In specific embodiments, CMS may be configured to detect job related issues such as job failure, delays, resource depletion, and/or the like, and notify relevant stakeholders, such as developers and QA engineers, of the same. In example embodiments, CMS may be configured to prioritize these notifications based on developer involvement. Upon code changes, the CMS may be configured to create containers for the code changes for evaluation and testing. These containers may undergo tests defined by smart contracts, which outline key metrics for quality assessment of the code change. In particular embodiments, containers that meet the smart contract conditions may be deployed to the production environment, (ii) CRS—the CRS may be configured to assist the developers to write code changes to resolve the identified issues. The CRS may include an integrated ML subsystem designed to analyze past code changes for similar issues. This ML subsystem may be configured to suggest code options to the developer in real-time, based on both past and ongoing code changes. The dynamic updating of suggestions ensures that they remain relevant and continuously refined, thereby enhancing the efficiency and effectiveness of the code development process, and (iii) PCMS-PCMS may be configured to address issues arising from multiple developers, often spanning multiple geographic locations, writing code changes concurrently to resolve the same issue. The PCMS may be configured to generate an atomic version of each code change upon every save action by a developer. This atomic version may include detailed information such as module and database dependencies, affected rows, test case coverage, and/or the like. The PCMS may also be configured to provide real-time test case outcomes. These atomic versions are shared with other developers working on the same issue, offering precise insight into each other's work, thereby enhancing collaboration and reducing work duplication.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

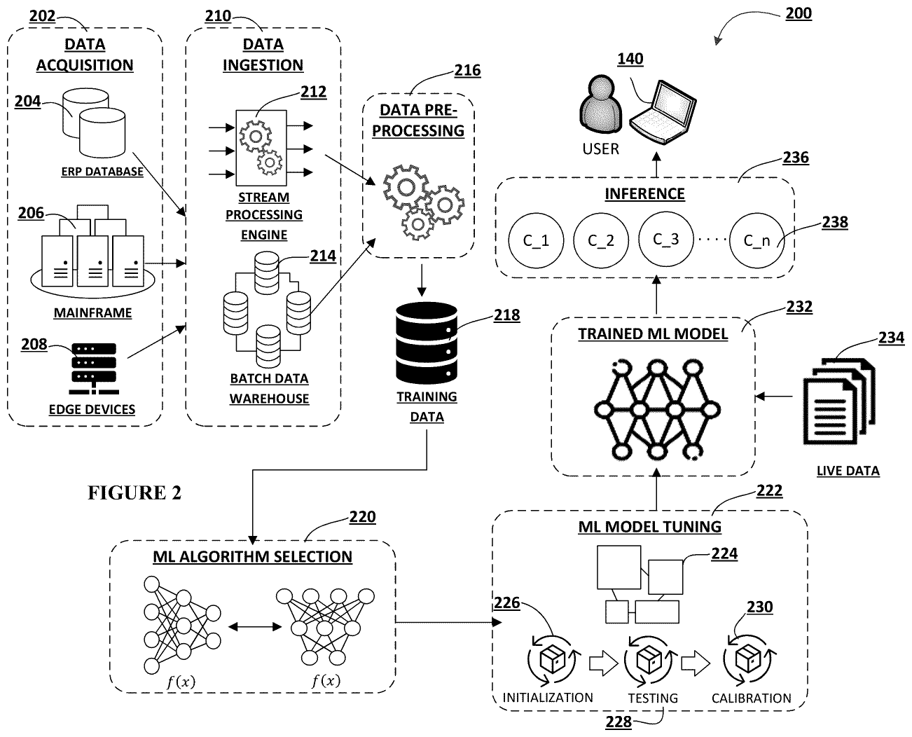

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

An NFT is a cryptographic record (referred to as “tokens”) linked to a resource. An NFT is typically stored on a distributed ledger that certifies ownership and authenticity of the resource, and exchangeable in a peer-to-peer network.

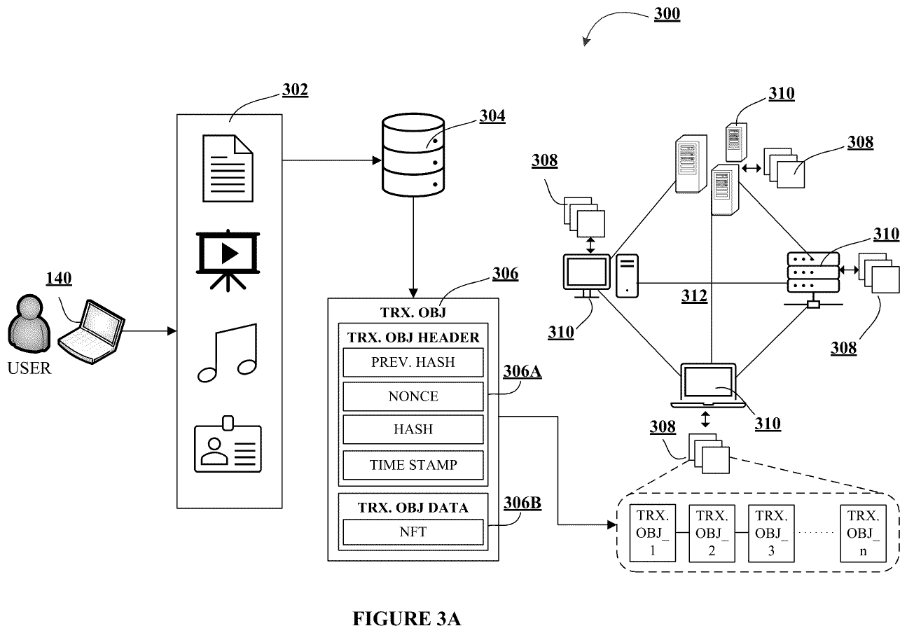

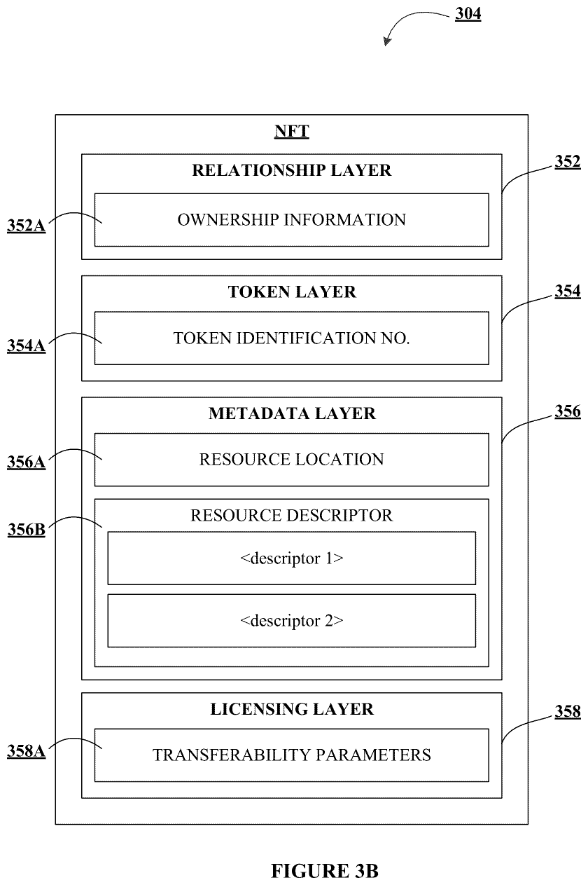

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, virtual world items, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce-a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. The transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process

As shown in FIG. 3A, the distributed ledger 308 may be maintained on multiple devices (nodes) 310 that are authorized to keep track of the distributed ledger 308. For example, these nodes 310 may be computing devices such as system 130 and end-point device(s) 140. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S1, the relationship between B1 and S1 as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

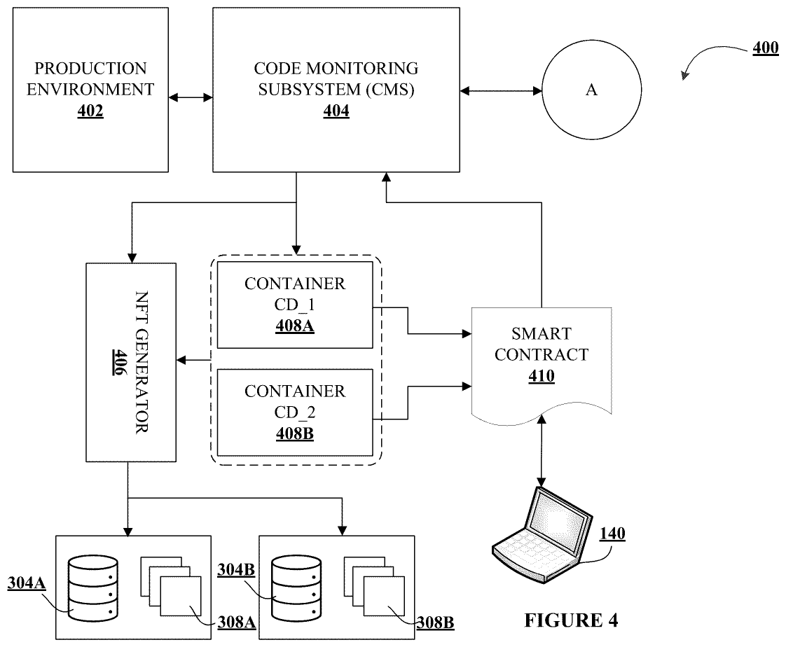

FIG. 4 is a data flow diagram 400 illustrating a role of the code monitoring subsystem (CMS) in reducing work duplication in parallel and concurrent software development environments, in accordance with an embodiment of the invention. As shown in FIG. 4, the CMS 404 may serve as a proactive monitoring tool that may be configured to continuously scan servers to identify active jobs in a production environment 402. In doing so, CMS 404 may identify jobs that may require code modification based on various conditions: job failure, delays, high data volume, failure to complete tasks within a set timeframe, and/or the like. In response, the CMS 404 may be configured to trigger alerts to all the stakeholder such as developers, quality assurance (QA) engineers, business analysts, and/or the like who are associated with a job. In this way, the CMS may ensure that the right individuals are alerted and can take timely action when issues arise in specific jobs.

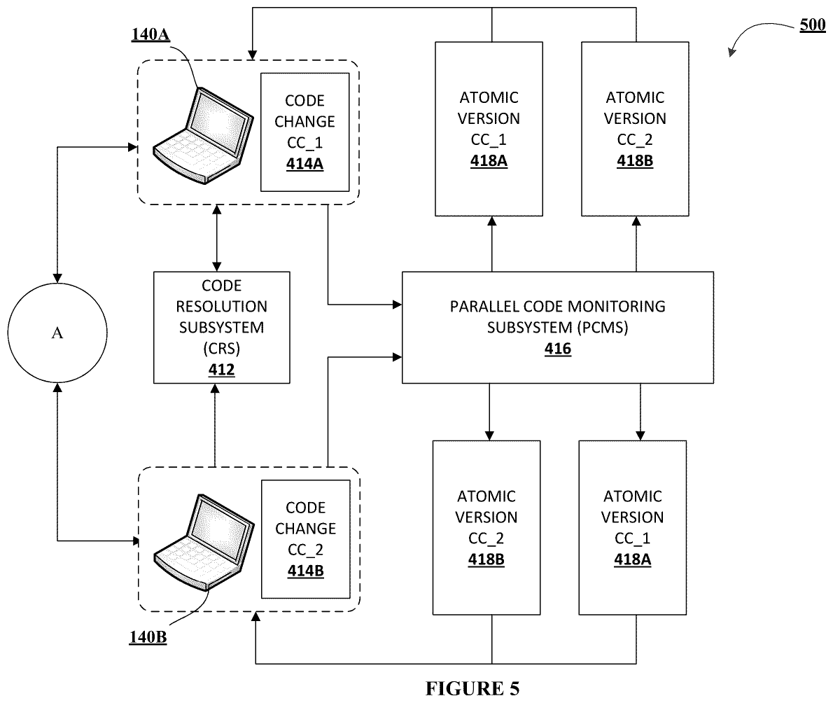

In response to these alerts, developers commence the process of working on the code changes associated with the identified code modification requirements. They may begin by reviewing the specifics of the alert, understanding the nature of the issue, and assessing the scope of the required code modification. Subsequently, in some embodiments, the developers may collaborate with other stakeholders, such as QA engineers and business analysts, to outline a plan of action, including defining objectives, setting timelines, and allocating resources. Once the plan is in place, developers may initiate the actual coding process, making the necessary modifications to address the issue. The code development process is further described in FIG. 5. Upon developing the code changes, the developers may submit the code to the CMS 404.

Upon receipt of the code change from the developers, the CMS 404 may be configured to create containers CD_1 408A and CD_2 408B corresponding to the code change submitted by the developers, thereby equipping the developers with the requisite resources for thorough evaluation and testing of each code modification. These containers may then be subjected to a series of specific tests to assess their quality and functionality. To standardize this testing process, a smart contract 410 may be employed. The smart contract 410 may outline key metrics such as the complexity metrics, exposure assessment, quality metrics, resource consumption, test coverage, business value, performance metrics, compliance score, cost metrics, and/or the like to determine the quality of each container. Containers CD_1 408A and CD_2 408B that meet the conditions specified in the smart contract 410 are automatically eligible for deployment. Individual stakeholders 140 can formulate smart contracts (e.g., smart contract 410) tailored to their unique requirements, featuring specific metrics.

As described herein, the performance of each container CD_1 408A, CD_2 408B is evaluated based on a range of metrics. The scores from each metric may then be aggregated into a weighted composite score for the container CD_1 408A, CD_2 408B. The composite score may serve as an indication of both the quality of the associated code change and the susceptibility of the container to errors. This composite score, along with the associated code change, is subsequently recorded in the form of an NFT 304A, 304B using an NFT generator 406. The NFT generator 406 may be a specialized software module designed to create unique digital tokens (e.g., NFT 304A, 304B) on a distributed ledger (e.g., distributed ledger 308A, 308B). The NFT generator 406 employs cryptographic algorithms to hash the composite score and the code change data, creating a unique digital fingerprint, as explained in further detail in FIGS. 3A and 3B.

FIG. 5 is a data flow diagram 500 illustrating a role of the parallel code monitoring subsystem (PCMS) and code resolution subsystem (CRS) in reducing work duplication in parallel and concurrent software development environments, in accordance with an embodiment of the invention. Upon receipt and acknowledgment of a notification, the developers 140A, 140B may commence work on resolving the issue, aided by the CRS 412 to expedite the process. In example embodiments, the CRS 140 may include an ML subsystem (not shown) that may be configured to analyze past code changes that have addressed similar code modification requirements. Based on this analysis, the ML subsystem can suggest code options to the developer during the code change development. These suggestions may be generated by comparing the current code modification requirements with past code changes, thereby providing the developers 140A, 140B with potentially effective solutions that have been previously implemented. The ML subsystem may be designed adapt dynamically. As the developers 140A, 140B make ongoing code changes 414A. 414B, the ML subsystem may update the suggested code options in real-time. This dynamic updating is based on both the ongoing code changes 414A, 414B made by the developer and the past code changes that were determined to be similar.

As shown in FIG. 5, each developer 140A, 140B may provide their own version of code change 414A, 414B for deployment, addressing the code modification requirement. For example, developer 140A may provide code change 414A and developer 140B may provide code change 414B. To further enhance collaboration and code quality, PCMS 416 may continuously monitor each developer 140A, 140B working on the same issue. Upon each save action by a developer 140A, 140B, the PCMS 416 may be configured to generate an atomic version 418A, 418B of the code change, complete with detailed information such as module dependency, database dependency, affected rows, scope of variables, line sequence, test case coverage, and/or the like. For example, the PCMS 416 may be configured to generate atomic version 418A for code change 414A provided by developer 140A. Similarly, the PCMS 416 may be configured to generate atomic version 418B for code change 414B provided by developer 140B. These atomic versions are then sent to the other developers working on the same issue, thereby allowing each developer to have precise insight into what the other developers are doing, enhancing collaboration across the entity, and reducing work duplication. For example, the PCMS 416 may provide developer 140A with atomic version 418A of code change 414A and atomic version 418B of code change 414B. Similarly, PCMS 416 may provide developer 140B with atomic version 418B of code change 414B and atomic version 418A of code change 414A. The developers 140A, 140B may then provide their respective code changes 414A, 414B to the CRS 404 (in FIG. 4) for continued processing.

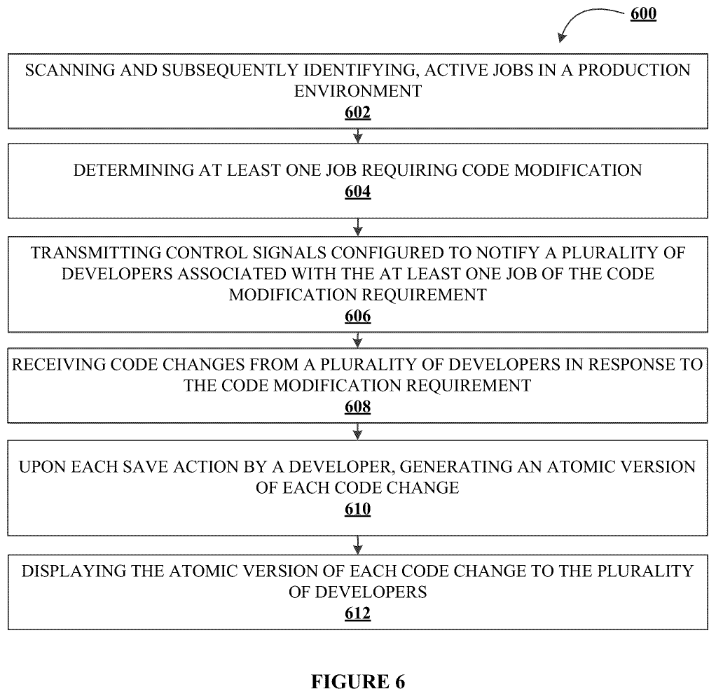

FIG. 6 illustrates a process flow 600 reducing work duplication in parallel and concurrent software development environments, in accordance with an embodiment of the disclosure. As shown in block 602, the process flow includes scanning and subsequently identifying, active jobs in a production environment. In some embodiments, a production environment may refer to a setting where software and other systems are put into operation for their intended uses by end-users. Unlike a development or testing environment, the production environment may be a live setting where any changes can directly affect the end-user experience. Therefore, monitoring and management in this environment are critical to ensure optimal performance and reliability. In some embodiments, an active job may refer to a currently running or scheduled task that the system is executing or prepared to execute. Active jobs may range from data processing tasks to complex computational operations. These jobs are crucial components in the workflow, and their performance can have a direct impact on the overall system efficiency and user satisfaction.

As discussed herein, the CMS may be configured to scan and identify the active jobs in the production environment. In this capacity, the CMS may be configured to continuously scan servers in the production environment to locate tasks that are either currently running or scheduled to run. In example embodiments, the act of scanning and identifying by the CMS may be automated and may be configured to operate at different intervals, depending on the needs of the system and the criticality of the jobs. Here, the CMS may use various criteria to identify these jobs, such as job IDs, process names, or other unique identifiers.

As shown in block 604, the process flow includes determining at least one job requiring code modification. In some embodiments, the CMS may be configured to assess the state and performance of each job to pinpoint those that may require code modification for various reasons. In example embodiments, a job requiring code modification could be one that has failed to execute as expected, leading to errors or system instability. Similarly, jobs that have experienced delays or have dawdled in their execution may also be flagged for code modification. These delays could be due to inefficient code, resource bottlenecks, or other issues that impede the job's timely completion. High data volume may be another criteria that the CMS may use to identify jobs requiring code modification. A sudden or unexpected inflow of data could overwhelm a job, causing it to slow down or fail. In such cases, code modification may be necessary to optimize data handling and processing capabilities. Additionally, jobs that do not complete within expected parameters, such as timeframes or computational limits, may be flagged. These could be jobs that either exceed their allocated resources or fail to meet performance benchmarks, indicating that the existing code may not be adequate for the task at hand.

In some embodiments, the CMS may employ machine learning techniques to enhance its capability to determine jobs requiring code modification within a production environment. For example, anomaly detection algorithms can be used to learn the normal behavior of jobs and flag deviations, thereby identifying jobs that may require code adjustments, predictive analysis can analyze historical data to forecast the likelihood of specific jobs needing modification, classification algorithms can categorize jobs based on attributes such as resource consumption or execution time, allowing for targeted monitoring, Natural Language Processing (NLP) can be employed to analyze logs and textual data for additional insights into job performance, real-time monitoring facilitated by machine learning can make instantaneous decisions about job modifications, which is particularly useful in high-velocity environments, root cause analysis can be conducted using advanced ML models to identify the underlying issues, thereby enabling more accurate determinations for code modification, and/or the like. In more complex scenarios, reinforcement learning algorithms can continuously refine the decision-making process based on past actions and outcomes. Through the integration of machine learning, the CMS becomes a more adaptive and efficient tool.

As shown in block 606, the process flow includes transmitting control signals configured to notify a plurality of developers associated with the at least one job of the code modification requirement. In some embodiments, the plurality of developers may have been associated with the at least one job or jobs in question (e.g., requiring code modification) in some past capacity. For example, the plurality of developers may have previously worked on the code, contributed to its development, have expertise in the specific area that the job pertains to, and/or the like. In some embodiments, the CMS may be configured to prioritize notifications to multiple developers based on their initial code contribution to the at least one job or jobs requiring modification, thereby ensuring that the most relevant developers are alerted first. By targeting developers who have a historical association with the job, the CMS may be configured to ensure that the notification reaches individuals who are most likely to have the requisite knowledge and skills to address the issue effectively. This targeted approach enhances the efficiency of the code modification process, as it reduces the time spent on understanding the context and nuances of the job that requires modification.

Upon receipt and acknowledgment of a notification for code modification, the developer may begin the process of resolving the issue. In this context, the developer may be assisted by the CRS, which serves as a centralized platform for overseeing the code development process. The CRS may be designed to expedite the resolution of issues by providing a structured environment for code modification. To augment the capabilities of the CRS, in some embodiments, an integrated ML subsystem may be included. In example embodiments, the ML subsystem may not be a mere adjunct but may be a critical component that enhances the efficiency and effectiveness of the code modification process.

In some embodiments, the ML subsystem may be configured to analyze past code changes that have been implemented to address similar code modification requirements. In this regard, in example embodiments, the ML subsystem may initially be configured to gather historical data on past code changes, including variables such as the type of issue addressed, the specific changes implemented, and the outcomes of those changes. Then, the ML subsystem may be configured to extract key features or attributes from this data for algorithmic analysis. Then, utilizing machine learning algorithms like clustering, classification, or regression, the ML subsystem may be configured to identify patterns or trends that are relevant to the current code modification requirement. Based on this analysis, the ML subsystem may then be configured to generate a set of data-driven code options that are presented to the developer. As the developer initiates code changes, the ML subsystem may be configured to employ real-time analytics to monitor these modifications and dynamically adapt its suggestions. In some embodiments, a feedback mechanism may also be integrated, where the outcomes of implemented suggestions are fed back into the ML model, thereby refining its predictive capabilities for future tasks. This comprehensive approach significantly reduces trial and error, expedites the code modification process, and enhances the overall quality of the code changes.

As shown in block 608, the process flow includes receiving code changes from a plurality of developers in response to the code modification requirement. As described herein, multiple developers may independently begin working on the same code modification requirement, unaware that other developers are also addressing the same issue. To further enhance collaboration and code quality, PCMS may continuously monitor each developer working on the same issue. In example embodiments, the PCMS may be configured to capture, in real-time, each developer's activities ranging from keystrokes to file changes and interactions with version control systems. In this way, the PCMS may be configured to receive code changes for the code modification requirement from the developers.

As shown in block 610, the process flow includes upon each save action by a developer, generating an atomic version of each code change. Upon each save action (manual or automated), the PCMS may generate an atomic version of the code change received from each developer. In specific embodiments, the PCMS may generate the atomic version through a combination of hashing algorithms and diffing techniques, creating a snapshot of the code that captures all relevant details at that specific moment. Alongside this, the PCMS may be configured to employ both static and dynamic code analysis tools to capture critical metadata, such as module and database dependencies, affected rows, scope of variables, and line sequences. Furthermore, the PCMS may be configured to display information related to the developer associated with a particular code change. This feature adds another layer of context to the code modification process, providing valuable insights that can facilitate better collaboration and decision-making. In example embodiments, the PCMS may be configured to store metadata about each developer, such as their areas of expertise, past contributions, and roles within the project. When a code change is made, the PCMS may be configured to automatically link the atomic version of the code with the corresponding developer's portfolio.

In some embodiments, in addition to code and metadata capture, the PCMS may be configured to run automated tests on these atomic versions, thereby providing real-time test case outcomes. In example embodiments, this functionality may be implemented using continuous integration tools that are triggered to execute test suites upon each save action. In some embodiments, the PCMS may be configured to incorporate conflict detection algorithms to alert developers of potential work duplication, thereby promoting more efficient use of resources. Furthermore, data synchronization algorithms may be employed to ensure that all atomic versions are seamlessly merged into the main code repository, keeping all developers aligned with the most recent code base.

As shown in block 612, the process flow includes displaying the atomic version of each code change to the plurality of developers. Once generated, these atomic versions, replete with metadata and test outcomes, are disseminated to other developers working on the same issue. This could be facilitated through real-time messaging protocols or integration with existing collaboration platforms.

In some embodiments, in response to receiving the code changes from the developers, the CMS may be configured to create containers corresponding to the submitted code change. A container may be a lightweight, stand-alone, and executable software package that may include everything needed to run a piece of software, including the code, runtime, system tools, libraries, and settings. As such, these containers may serve as isolated environments that equip the developer with the necessary resources for a comprehensive evaluation and testing of each code modification. In scenarios where multiple developers are addressing the same issue, the CMS can create individual containers for each version of the code change submitted by each developer.

In some embodiments, to ensure a standardized testing process, the CMS may employ smart contracts that outline key metrics such as complexity, exposure assessment, quality, resource consumption, test coverage, business value, performance, compliance, cost, and/or the like. These smart contracts may serve as binding agreements that specify the conditions a container must meet to be eligible for deployment. While the metrics may be consistent across different smart contracts, the values or conditional parameters can vary. Stakeholders have the flexibility to tailor smart contracts to their unique requirements. In cases where no comparable smart contract exists, the CMS may be configured to generate a predefined smart contract for stakeholder approval.

In some embodiments, the CMS may be configured to test each container in a simulated production environment to closely mimic real-world conditions. A range of metrics is used to evaluate the performance of each container. In example embodiments, these metrics may be used to determine a composite score for each container reflecting the container's susceptibility to errors. In specific embodiments, the metrics may not be uniformly weighted; each may be assigned a specific weight based on its relevance to the entity's objectives. The scores from these metrics are aggregated into a weighted composite score, which serves as an indicator of both the quality of the associated code change and the container's susceptibility to errors.

In some embodiments, the composite score, along with the associated code change, is recorded in the form of an NFT. The NFT may act as a unique identifier and value representation for the container, providing a secure and immutable record of the code change and its associated quality metrics. Once generated, this NFT may be recorded in a distributed ledger of the developer associated with the code change.

In some embodiments, when code changes submitted by multiple developers are eligible for deployment, the CMS may be configured to select code changes with a more favorable composite score. In some other embodiments, when code changes submitted by multiple developers are eligible for deployment, the stakeholders may have authorization to select a code change for deployment. In still other embodiments, when code changes submitted by multiple developers are eligible for deployment, developers with higher authorization levels may select the code change for deployment. In still other embodiments, when code changes submitted by multiple developers are eligible for deployment, developers with higher notification priority may select the code change for deployment.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for reducing work duplication in parallel and concurrent software development environments, the system comprising:
a code monitoring subsystem (CMS) configured to:
scan and subsequently identify active jobs in a production environment;
determine at least one job requiring code modification;
transmit control signals configured to notify a plurality of developers of the code modification requirement, wherein the plurality of developers is associated with the at least one job; and
a parallel code monitoring subsystem (PCMS) operatively coupled to the CMS and is configured to:
receive code changes from the plurality of developers in response to the code modification requirement;
upon each save action by a developer, generate an atomic version of each code change; and
display the atomic version of each code change to the plurality of developers.

2. The system of claim 1, further comprising a code resolution subsystem (CRS) operatively coupled to the CMS, wherein the CRS is configured to:
monitor code change development initiated by the plurality of developers upon being notified of the code modification requirement for the at least one job.

3. The system of claim 2, wherein the CRS comprises a machine learning (ML) subsystem configured to:
determine past code changes that have addressed similar code modification requirements; and
suggest code options to the plurality of developers during the code change development based on at least the past code changes.

4. The system of claim 3, wherein the ML subsystem is further configured to:
dynamically update the suggested code options based on ongoing code changes made by the plurality of developers and the past code changes.

5. The system of claim 1, wherein the CMS is further configured to prioritize notifications to the plurality of developers based on their initial code contribution to the at least one job.

6. The system of claim 1, wherein the CMS is further configured to:
receive the code changes from the plurality of developers; and
create a container for each code change.

7. The system of claim 6, wherein the CMS is further configured to:
simulate a production environment; and
implement a code test protocol on each container in the simulated production environment.

8. The system of claim 7, wherein the code test protocol comprises a smart contract, wherein the smart contract comprises one or more conditions associated with one or more performance metrics.

9. The system of claim 8, wherein the smart contract is associated with a stakeholder.

10. The system of claim 8, wherein the one or more performance metrics comprises at least complexity, exposure assessment, code quality, resource consumption, test coverage, business value, performance metrics, compliance, and code cost.

11. The system of claim 8, wherein the CMS is further configured to:
for each container, determine one or more values for the one or more performance metrics in response to implementing the code test protocol; and
deploy the container in an instance in which the one or more values for the one or more performance metrics meets the one or more conditions.

12. The system of claim 11, wherein the CMS is further configured to:
for each container, determine one or more weights associated with the one or more performance metrics; and
determine a composite value for each container based on at least the one or more weights and the one or more values, wherein the composite value serves as a metric for assessing the container's susceptibility to errors.

13. The system of claim 12, further comprising a non-fungible token (NFT) generator, wherein the NFT generator is configured to:
generate an NFT for each container, wherein the NFT comprises at least the composite value of the container and a code change associated with the container; and
record the NFT in a distributed ledger.

14. The system of claim 13, wherein the NFT generator is further configured to:
generate a transaction object for the NFT;
deploy the transaction object on the distributed ledger;
capture a distributed ledger address associated with the recording;
generate a notification indicating that the transaction object has been created for the NFT in the distributed ledger, wherein the notification comprises at least the distributed ledger address; and
transmit control signals configured to cause a user input device of the developer associated with the code change to display the notification.

15. A computer program product for reducing work duplication in parallel and concurrent software development environments, the computer program product comprising a non-transitory computer-readable medium comprising code configured to cause an apparatus to:
scan and subsequently identify, active jobs in a production environment;
determine at least one job requiring code modification;
transmit control signals configured to notify a plurality of developers of the code modification requirement, wherein the plurality of developers are associated with the at least one job;
receive code changes from the plurality of developers in response to the code modification requirement;
upon each save action by a developer, generate an atomic version of each code change; and
display the atomic version of each code change to the plurality of developers.

16. The computer program product of claim 15, wherein the code further causes the apparatus to:
monitor code change development initiated by the plurality of developers upon being notified of the code modification requirement for the at least one job.

17. The computer program product of claim 16, wherein the code further causes the apparatus to:
determine past code changes that have addressed similar code modification requirements; and
suggest code options to the plurality of developers during the code change development based on at least the past code changes.

18. A method for reducing work duplication in parallel and concurrent software development environments, the method comprising:
scanning and subsequently identifying, active jobs in a production environment;
determining at least one job requiring code modification;
transmitting control signals configured to notify a plurality of developers associated with the at least one job of the code modification requirement;
receiving code changes from a plurality of developers in response to the code modification requirement;
upon each save action by a developer, generating an atomic version of each code change; and
displaying the atomic version of each code change to the plurality of developers.

19. The method of claim 18, wherein the method further comprises:
monitoring code change development initiated by a plurality of developers upon being notified of the code modification requirement for the at least one job.

20. The method of claim 19, wherein the method further comprises:
determining past code changes that have addressed similar code modification requirements; and
suggesting code options to the plurality of developers during the code change development based on at least the past code changes.
